(19) United States
(12) Patent Application Publication
(10) Pub. No.: US 2003/0034987 A1
(43) Pub. Date: Feb. 20, 2003

(54) Handheld computer having moveable segments that can be adjusted to affect a size of the handheld computer

(76) Inventors: William Webb, Redwood City, CA (US); Anna-Pia Slothower, Sausalito, CA (US); Lawrence Lam, San Jose, CA (US); Rich Gioscia, Santa Clara, CA (US)

Correspondence Address: HICKMAN PALERMO TRUONG & BECKER, LLP, 1600 WILLOW STREET, SAN JOSE, CA, 95125, US

(21) Appl. No.: 09/932,213

(22) Filed: Aug. 17, 2001

(51) Int. Cl. G09G 5/00

(52) U.S. Cl. 345/629

(57) ABSTRACT

A handheld computer is provided that includes a first module combined with one or more modules. The first module includes a housing having one or more coupling surfaces, with each coupling surface including a coupling mechanism. A second module is coupleable to the first module. The second module includes a third coupling surface having a second coupling mechanism for mating with the first coupling mechanism. The third coupling surface is positioned on the second module so as to abut at least partially against the second coupling surface when the first coupling mechanism is mated with the second coupling mechanism.

### FIELD OF THE INVENTION

The present invention relates to handheld computers. In particular, the present invention relates to a handheld computer comprised of a moveable assembly that is adjustable to affect a size of the handheld computer.

### BACKGROUND OF THE INVENTION

Handheld computers, typically referred to as personal digital assistants (PDAs), are intended to be mobile devices. In general, small sizes are desired for handheld computers to enhance mobility. However, there are constraints to how small a handheld computer can be for convenience of the user. In particular, certain characteristics of handheld computers require a minimum amount of space on the exterior housing of the handheld computer.

Most handheld computers require a minimum size display. The minimum display size is set by balancing considerations such as mobility with the need for the user to view data, such as personal management information, pictures, and text pages. For some handheld computers, the size of the display may also need to be large enough to provide a character input mechanisms for the user. For example, some handheld computers incorporate character recognition logic as a primary means for the user to enter character data into the handheld computer. The displays for the handheld computer may be made to be contact-sensitive. A portion of the display may be combined with logic to provide an immediate character recognizer for recognizing gestures or strokes entered onto a portion of the display as characters. Other displays may be used to display a virtual keyboard. The immediate character recognition regions and virtual keyboards require the displays to be of a minimum size to support those kinds of character entry.

The size of the handheld computer typically must also accommodate mechanical actuators, such as buttons or pivot switches. These are typically placed on the same surface where the display is viewable to enable users to coordinate button actions with what is shown on the display.

As battery and printed circuit board technology becomes more advanced, the display size and mechanical actuators are increasingly becoming the primary factors that determine the size of the handheld computer. Reducing the length of the handheld computer requires sacrificing features of the display and/or buttons.

### SUMMARY OF THE INVENTION

Embodiments of the invention provide for a handheld computer comprising a first segment moveably coupled to a second segment. The second segment can be positioned to overlay a portion of the first segment so as to reduce a length of the handheld computer.

In an embodiment, the first segment provides a display. The handheld computer can be manipulated into a contracted position so that the second segment is overlaid over a portion of the display on the first segment. The handheld computer can be manipulated into an extended position, so that all of the display is viewable.

In an embodiment, the second segment has mechanical actuators. The display of the first segment is contact-sensitive, and includes an immediate character recognition region. In the contracted position, the mechanical actuators overlay the immediate character recognition region. In the extended position, the immediate character recognition region is accessible with the mechanical actuators.

### BRIEF DESCRIPTION OF THE DRAWINGS

Embodiments of the invention are illustrated by way of example, and not by way of limitation, in the figures of the accompanying drawings. Like reference numerals are intended to refer to similar elements among different figures.

FIG. 1 is a frontal view of a handheld computer having moveable segments configured in an extended position.

FIG. 2 is a frontal view of the handheld computer, with the moveable segments configured in a contracted position.

FIG. 3 is a back view of the handheld computer, with the moveable segments configured in an extended position.

FIG. 4 is a back view of the handheld computer, with the moveable segments configured in a contracted position.

FIG. 5 is a side view of the handheld computer, with the moveable segments configured in an extended position.

FIG. 6 is a cross-sectional view of FIG. 5, cut along lines A-A

FIG. 7 is a side view of the handheld computer, with the moveable segments configured in a contracted position.

FIG. 8 is an exploded isometric view of a first moveable segment of the handheld computer.

FIG. 9 is an isometric view of a second moveable segment of the handheld computer.

FIG. 10 is a side view of a handheld computer formed by a first segment slideable connected to a second segment, the two segments being positioned in an extended position.

FIG. 11 is a side view of a handheld computer formed by a first segment slideable connected to a second segment, the two segments being positioned in a contracted position.

FIG. 12 is a partial, side cross-sectional view of the handheld computer formed by a first segment slideable coupled to a second segment.

FIG. 13 is a back isometric view of a handheld computer, showing a first set of connecting mechanisms for moveably connecting two segments of a handheld computer.

FIG. 14 is a front isometric view of handheld computer, showing a second set of connecting mechanisms for moveably connecting two segments of a handheld computer.

FIG. 15 is a cross-sectional view taken along lines A-A of FIG. 13.

FIG. 16 is a cross-sectional view taken along lines B-B of FIG. 13.

FIG. 17 illustrates a hardware diagram for a handheld computer coupleable to one or more accessory devices.

### DETAILED DESCRIPTION OF THE INVENTION

Embodiments of the invention describe a handheld computer having moveable segments to affect a size of the handheld computer. In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

A. Overview

In an embodiment, a handheld computer includes multiple segments that are moveably connected and adjustable to affect an overall size of the handheld computer.

In one embodiment, a first segment is moveably connected to a second segment. The first segment includes a contact-sensitive display. The second segment includes an input mechanism. The first segment and second segment can be moved between a contracted position and an extended position. In the contracted position, the second segment is overlaid relative to the first segment so that a portion of the display assembly is not accessible. In the extended position, the second segment is moved away from the display assembly so that all of the display assembly is accessible to a user of the handheld computer.

In another embodiment, a second segment is slideably coupled to the first segment. The second segment can be positioned relative to the first segment to overlay and reduce an area of the contact-sensitive display assembly.

Moveable refers to movement in one or more directions, including rotations, and combinations of motions. Slideable means movement primarily in one direction.

A display surface is accessible if the surface can be contacted by the user. The display surface does not have to be contact-sensitive to be accessible. The term accessible refers only to a physical relationship between the display and other surfaces of the handheld computer. If the display surface is accessible, then that display surface is not being shielded by another component or surface of the handheld computer.

Among other advantages, embodiments of the invention allow for a handheld computer to vary the overall length of the handheld computer by adjusting the position of the segments relative to one another. A user can maintain the handheld computer in a shortened or contracted state if the user does not need to use certain features that can be covered by the segments in the contracted position. For example, portions of the display dedicated to or used primarily for character entry may be covered by the contracted segments of the handheld computer if the user does not need to use the character entry feature of the handheld computer. This allows the user to extend the handheld computer for limited instances when character entry is desired. Therefore, minimization of the size of the handheld computer is not as constrained by character entry features or input mechanisms.

Another advantage is that buttons or other mechanical input mechanisms can be more centrally disposed on the handheld computer. This allows the user to operate the device with one hand, with a thumb or extending to manipulate the buttons. In this configuration, the weight of the handheld computer is more evenly distributed to lessen the strain on the user's hands and thumbs.

B. Configurations for Handheld Computer With Moveable Segments

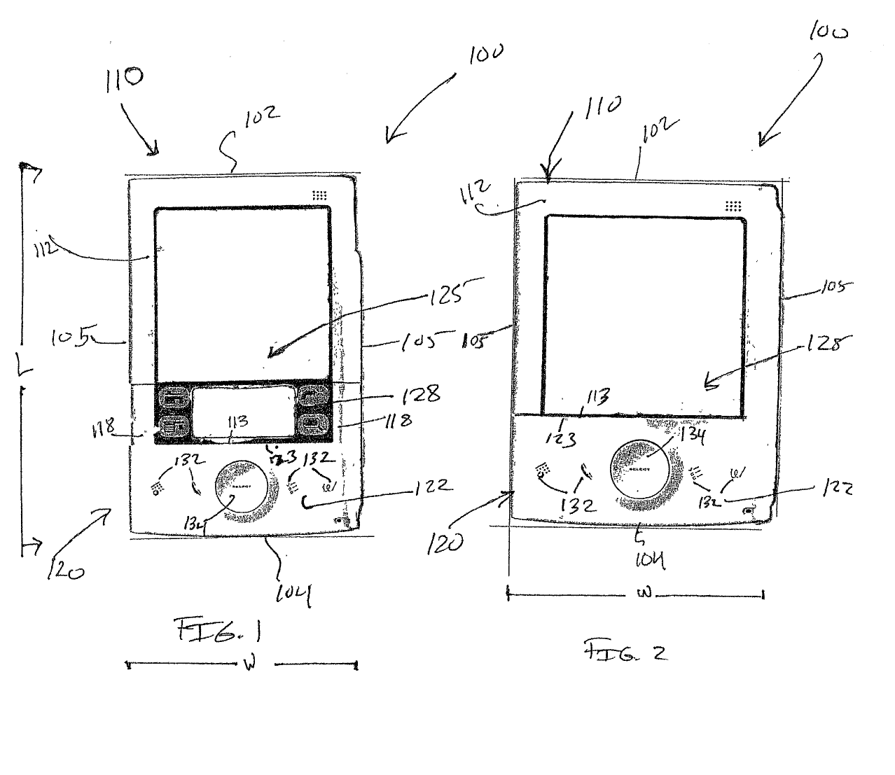

FIG. 1 is a front view of a handheld computer 100, under an embodiment of the invention. The handheld computer 100 includes a first segment 110 moveably coupled to a second segment 120. In FIG. 1, second segment 120 is fully extended in relation to first segment 110.

The first segment 110 and/or the second segment 120 may be moved along an axis to affect a size of the handheld computer. The movement by the first segment 110 and/or the second segment 120 may be linear. In one embodiment, one segment slides relative to another segment to affect the size of handheld computer 100.

A front surface 112 of first segment 110 provides access to a contact-sensitive display assembly 125. The display assembly 125 may include an immediate character recognition region 128, and an output region 126. A front panel 122 of second segment 120 provides a plurality of actuatable mechanisms.

The handheld computer 100 may be referenced to a top 102 and a bottom 104, and a pair of lateral sides 105. In the extended position, a top edge 123 of second segment 120 is positioned proximally to a bottom edge 113 of first segment 110. A length L of handheld computer 100 is defined by a distance between top 102 and bottom 104. A width W of handheld computer 100 is defined by a distance between lateral sides 105, 105.

Embodiments of the invention provide for the length of handheld computer 100 to be variable. In one embodiment, second segment 120 is moveable to position bottom 104 closer or farther away from top 102 on first segment 110.

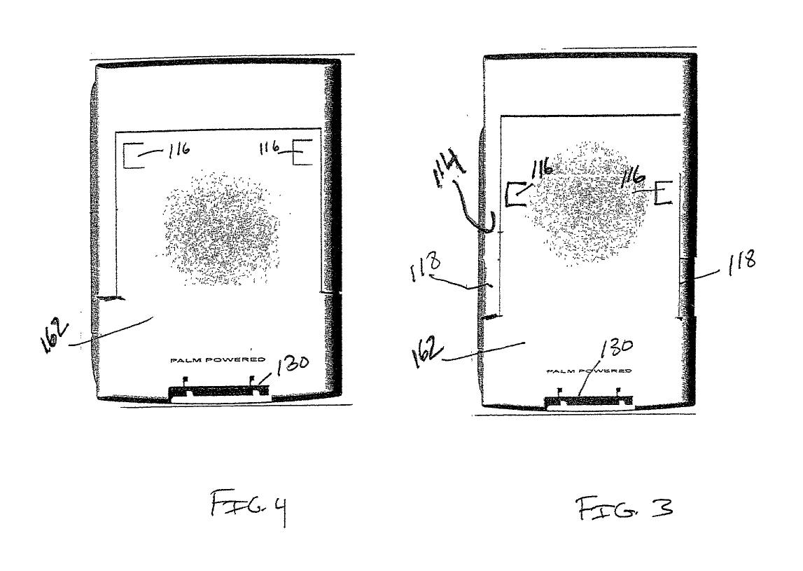

The first segment 110 includes a reduced section 118. The reduced section 118 is formed by regions of first segment 110 that have a reduced peripheral thickness. The overall peripheral thickness of reduced section 118 enables second segment 120 to move over first segment 110, as shown by FIG. 2. The reduced section 118 may be located on first segment 110 adjacent to second segment 120. In one configuration, reduced section 118 includes recesses formed into front surface of first segment 110, between each lateral side 105 and display assembly 125. The reduced section 118 may include one or more recesses that extend peripherally around first segment 110.

The display assembly 125 may be formed by a combination of a digitizer pad and screen. The screen and digitizer may be overlaid on all or portions of each other. In one implementation, the immediate character recognition region 128 may be formed by the digitizer pad, without the screen. Logic may be included with handheld computer 100 to recognize characters entered onto the digitizer pad through contact by a stylus type device. This configuration for display assembly 125 may correspond to a GRAFFITI handwriting area provided on handheld computers operating a PALM OS. In another implementation, immediate character recognition region 128 may be formed with the digitizer pad and digitizer completely overlaid with each other. Logic may be implemented to recognize characters entered onto the screen and digitizer combination. This configuration may correspond to a jot recognition area of a handheld computer operating a POCKET PC operating system.

The actuatable mechanisms provided on front panel 122 of second segment 120 include a combination of actuation mechanisms 132, as well as a multi-directional component 134. The actuation mechanisms 132 are mechanisms that have one of two states-actuated and not actuated. The multi-directional component 134 has multiple states-one state for each direction it can be actuated in, and a non-actuated state. The multi-directional component 134 may also have a center actuation state, corresponding to being centrally contacted or pressed straight down. The actuatable mechanisms 132 and/or multi-directional component 134 may be formed from buttons, contact-sensitive surfaces, or other mechanical switches.

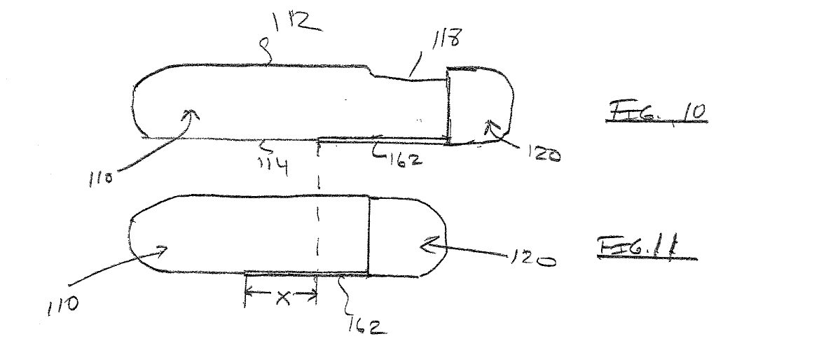

In one embodiment, actuatable mechanisms 132 comprise a thin rigid membrane that is disposed over the buttons to create actuation surfaces. An example such an embodiment is shown in FIG. 8.

The immediate character recognition region 128 uses a look-up table or other similar data structure to match a shape of a contact stroke with an input. In a typical use, immediate character recognition region 128 is used for character entry, and actuatable mechanisms 132 and multi-directional member 134 are used for selection of displayed data.

FIG. 2 is a front view of handheld computer 100 in a contracted position. In the contracted position, second segment 120 is moved over the portion of first segment 110 corresponding to reduced sections 118. A top edge 123 of second segment 120 is moved to be distal to bottom edge 113 (FIG. 1) of first segment 110. The top edge 123 moves a distance of X from the extended position to the contracted position. As a result, the overall length L of handheld computer 100 is reduced by X when handheld computer 100 is in the contracted position.

In one embodiment, distance X may correspond to a length of immediate character recognition region 128. As a result, front panel 122 of second segment 120 is positioned in front of immediate character recognition region 128 when handheld computer 100 is in the contracted state. The immediate character recognition region 128 is no longer accessible to a user when second segment 120 is moved into the contracted position.

According to one configuration, handheld computer 100 is in a character entry mode in the extended position. In the character entry mode, handheld computer uses a feature such as the display to receive characters. Other embodiments may provide for a mechanical keyboard that can be used to enter characters in the character entry mode. In the contracted position, handheld computer 100 may be in a selection mode. The actuatable mechanisms 132 and multi-directional member 134 may be used to make selections based on information provided on the screen of display assembly 125. For example, menu items, data entries, or applications may be selected using actuatable mechanisms 132. The actuatable mechanisms may cover or otherwise overlap the character entry feature when handheld computer 100 is in the selection mode.

FIG. 3 is a back view of handheld computer 100 in the extended position. A back panel 162 of second segment 120 is disposed over a back surface 114 of first segment 110. A pair of coupling features 116 are formed into back panel 162. The coupling features 116 are for detachably coupling to accessory devices, such as modems. The reduced section 118 is also disposed on back surface 114 of first segment 110. In the extended position, back panel 162 of second segment 120 can be moved into the extended position to expose reduced section 118.

A connector 130 is provided on a bottom surface 135. In one configuration, connector 130 is a feature of second segment 120, and bottom surface 135 is a region on second segment 120. The connector 130 may be used to couple to an accessory device, such as a cradle for a docking port. The connector 130 may also be used to couple to an accessory device that is secured to the back of handheld computer 100 using coupling features 116.

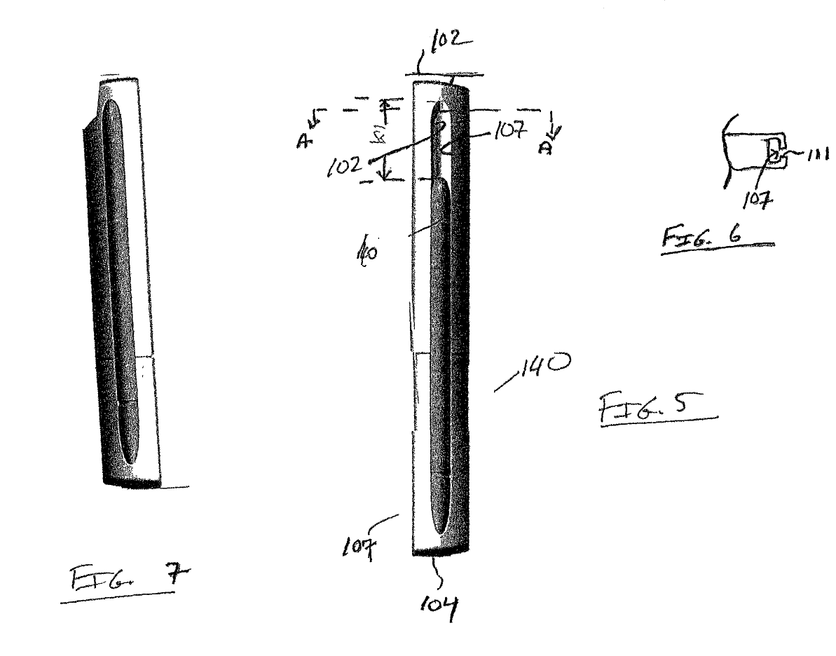

FIG. 4 is a back view of handheld computer 100 in the contracted position. The second segment 120 is moved over reduced sections 118, shrinking the length of handheld computer 100. The bottom surface 135 and connector 130 are not affected when handheld computer 100 is in the contracted position.

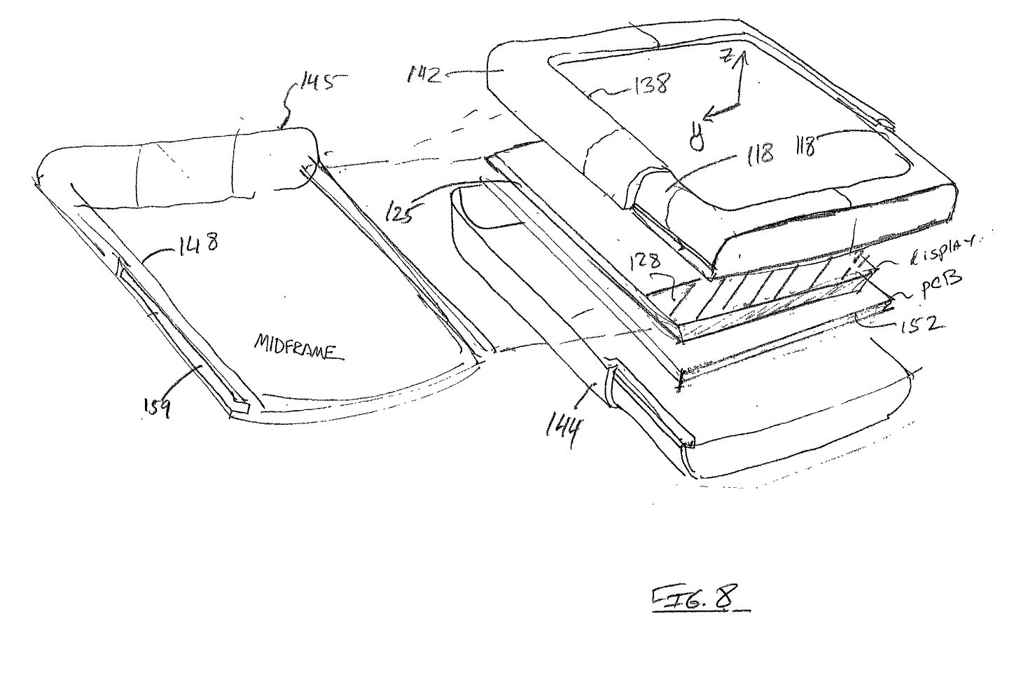

FIG. 5 is a side view of handheld computer 100 in the extended position. The lateral side 105 may include one or more accessory slots 107. The accessory slot 107 is formed as a partially-enclosed opening that extends lengthwise from near top 102 towards bottom 104. The accessory slot 107 is shown engaged with a stylus 140. In the extended position, accessory slot 107 is larger than stylus 140, so that rail gap 109 is formed between the top of the rail and stylus 140.

A lengthwise opening in accessory slot 107 permits for extensions to connect onto the stylus 140 or other stylus shaped member contained with accessory slot 107. The extensions can extend out of accessory slot 107 to form another type of accessory device. For example, a spine may be substituted for stylus 140. A cover portion may be attached to the spine using the lengthwise opening in accessory slot 107.

FIG. 6 is a cross-sectional view of FIG. 5, cut along lines A-A. The accessory slot 107 includes a lengthwise opening 111 that is formed along a majority of the rail's length. The opening 111 permits for devices that engage accessory slot 107 to include sections that extend out of the accessory slot 107.

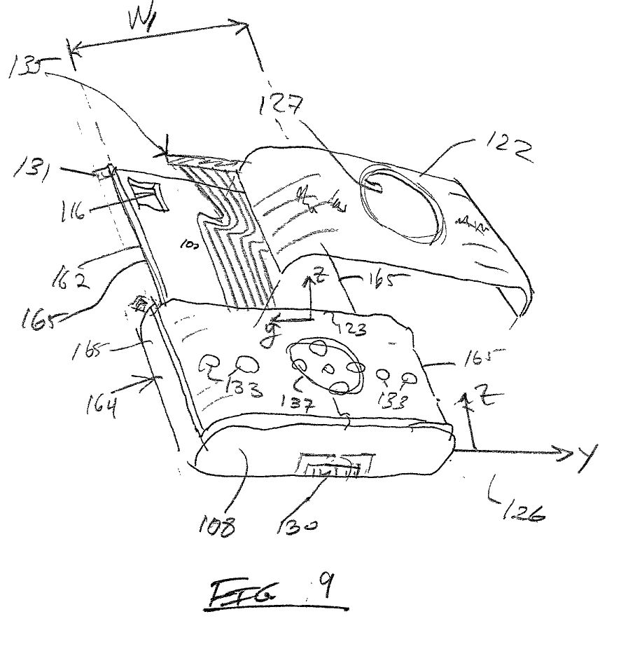

FIG. 7 is a side view of handheld computer 100 in the contracted position. The accessory slot 107 may be reduced in length, but still long enough to accommodate stylus 140.

The accessory slot 107 may be a housing feature on one or both of the other lateral side 105. In an embodiment, each lateral side 105 includes accessory slot 107. One of the rails 107 may be used to hold stylus 140. Another accessory slot 107 may be used to hold the spine of another accessory device.

C. Construction of Moveable Segments

FIG. 8 is an exploded isometric view of handheld computer 100, showing construction of first segment 110. The first segment 110 includes a front shell 142 and a back shell 144. The display assembly 125 is positioned between the front shell 142 and the back shell 144. A printed circuit board 152 is positioned underneath display assembly 125. The midframe 145 forms a peripheral strip of the housing for handheld computer 100, between front shell 142 and back shell 144.

In one construction, display assembly 125 is located within a space provided by front shell 142. The front shell 142 includes an opening 138 where display assembly 125 is accessible to a user for viewing or for contact. The reduced section 118 is formed on a bottom portion of front shell 142 and back shell 144. The reduced section 118 has dimensions in the vertical direction Z, and in the lateral direction Y, that are reduced in comparison to the remainder of front shell 142 and back shell 144.

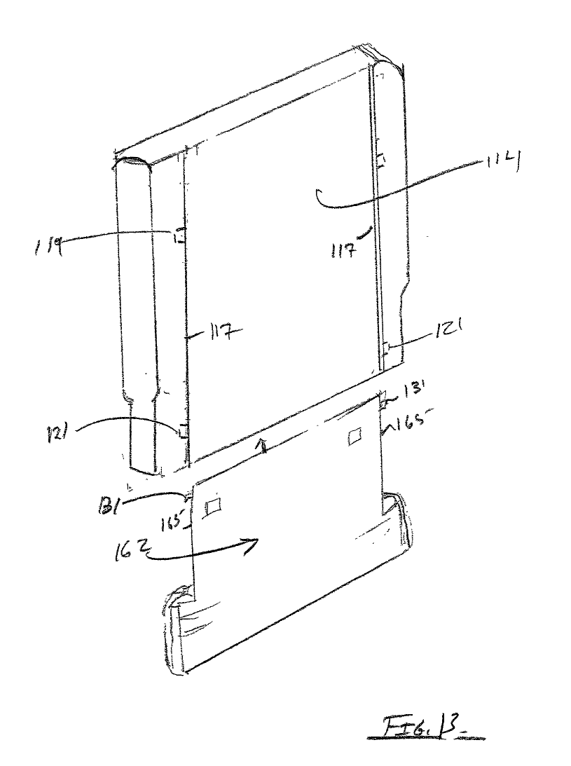

The midframe 145 includes an opening 148 to retain PCB 152. The midframe 145 may be formed by three of four orthogonally aligned legs that form a perimeter portion of handheld computer 100. Each lateral side 105 of handheld computer 100 includes a surface comprising portions of front shell 142, back shell 144, and midframe 145. As described in greater detail with FIGS. 11 and 12, midframe 145 is provided one or more rails 159 for receiving a connecting element of second segment 120. The midframe 145 may extend to both lateral sides 105 of handheld computer 100, and each lateral side may have rail 159 formed therein.

The display assembly 125 may be formed from a digitizer combined with a screen. The immediate character recognition region 128 may be located towards the bottom of first segment 110.

As described, back shell 144 includes portions of reduced sections 118, that mirror the shape and location of the portion of reduced section in front shell 142. When front shell 142 and back shell 144 are combined, the resulting reduced section 118 form a region that allows for second segment 120 to slide over first segment 110.

In an embodiment, midframe 145 is formed from a moldable material such as plastic or rubber. The first segment 110 and second segment 120 may be plated with metal or other hard materials.

FIG. 9 is an isometric view of second segment 120 for handheld computer 100. The second segment 120 includes a housing 164 combined with back plate 162. The back plate 162 slides along the back surface of handheld computer 100. The housing 164 has dimensions in the vertical direction Z, and in the lateral direction Y, that match those dimensions of first segment 110. In the contracted position, top edge 123 of second segment 120 is abutted against bottom edge 113 of first segment 110,. The dimensions of housing 164 enable second segment 120 to be combined with first segment 110 to give the appearance that one housing contains components of both first segment 110 and second segment 120.

In an embodiment, front panel 122 of second segment 120 is mounted on top of an interior panel 126. The interior panel 126 includes pressable mechanical actuators, including actuators 133 for input mechanisms 132, and actuators 137 for multi-directional member 134. The front panel 122 is a thin, flexible membrane that can be flexed in regions corresponding to the position of actuators 133 and 137. For example, front panel 122 may be a thin sheet-metal that can be pressed inwards at select locations corresponding to where actuators 133, 137 reside on interior panel. Markings may be provided on front panel 122 to indicate location of the actuators 133, 137. An opening 127 may house a joystick, pad, cross-member or other device for multi-directional member 134. The device housed within opening 127 may be used to selectively contact one or more of the actuators 137.

A flex cable 135 may be extended from within housing 164. The flex cable 135 may connect to the actuators 133, 137 to extend communications from those actuators to the PCB 152. The flex cable 135 is provided on a front surface of back plate 162. The back plate 162 is moveable a distance X along the back surface 114 of first segment 110. The coupling features 116 may be shaped as openings on back plate 162, to enable attachment of mechanical couplings extended from an accessory device.

The second segment 120 includes a bottom surface 108 for handheld computer 100. The bottom surface 108 provides access to connector 130. Access to connector 130 is not altered as second segment 120 is moved between the contracted position and the extended position. While bottom surface 108 is shown to be relatively flat and orthogonal to front panel 122, embodiments of the invention provide for bottom surface 108 to be contoured into the shape of the back plate 162 and front panel 122. Furthermore, connector 130 may be disposed along both a bottom and back plane.

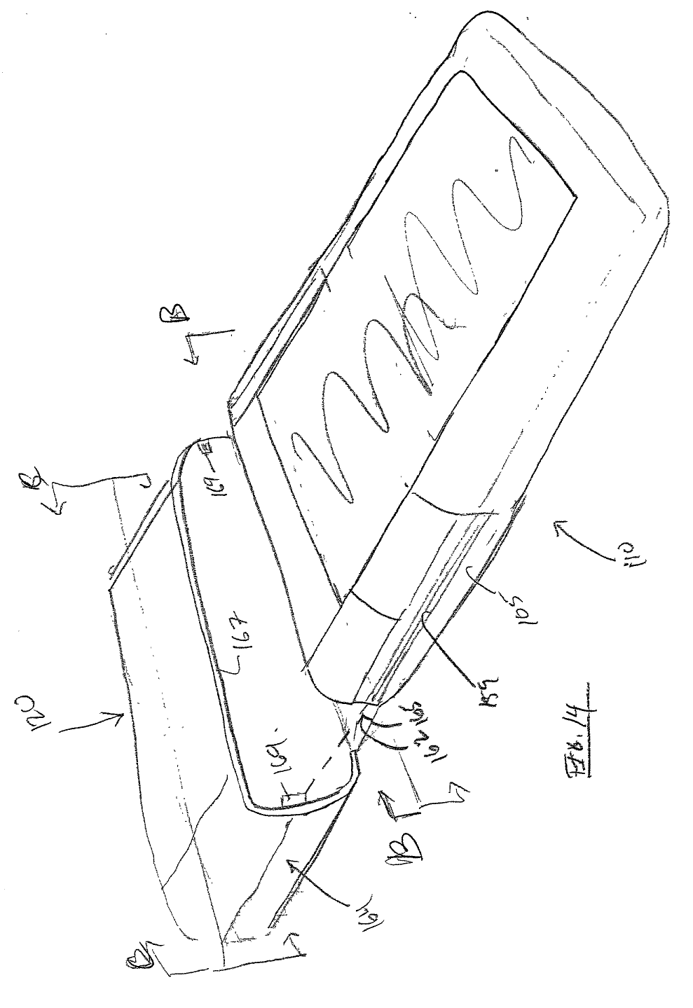

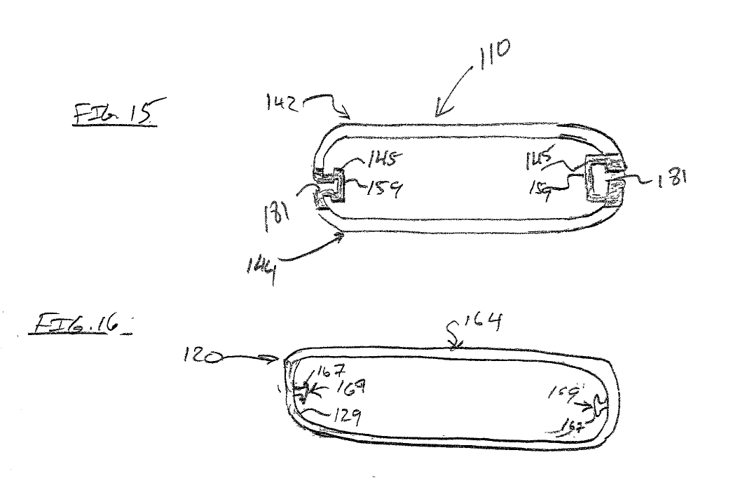

The back plate 162 includes lateral sides 165, 165. A distance WI between lateral sides 165 is less than the distance W between lateral sides 105 of first segment 110 (See FIG. 1). As will be described with FIG. 13, lateral sides 165 maybe shaped to be substantially liner in order to engage corresponding ridges 117, 117 on the back surface 114 of first segment 110. A connecting member 131 is positioned towards the top of back plate 162. As will be described in FIG. 14, the connecting member 131 is configured to engage the ridges 117 on the back surface 114 of first segment 110.

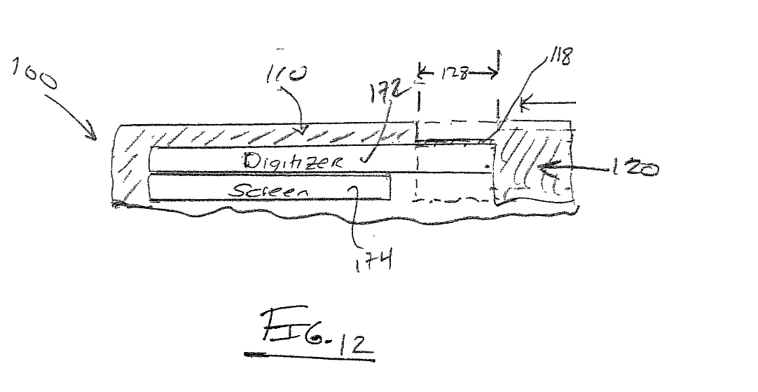

FIG. 10 is a simplified side view of first segment 110 and second segment 120 in the extended position. The reduced section 118 of first segment 110 is exposed. The back panel 162 of second segment 120 is provided adjacent back surface 114 of first segment 110, opposing the front surface 112.

In FIG. 11, back panel 162 is moved the distance X along the bottom surface 114. The direction is unilateral, so that back panel 162 is sliding along back surface 114. The second segment 120 is moved over the reduced sections 118 of first segment 110.

FIG. 12 is a side cross-sectional view of handheld computer 100, showing first segment 110 and second segment 120 configured with respect to display assembly 125. FIG. 11 is a partial view, showing only a thickness of handheld computer 100 corresponding to where display assembly 125 is housed.

In one embodiment, display assembly 125 comprises a digitizer 172 combined with a screen 174. This construction provides for a contact-sensitive display assembly 125. Input may be entered onto display assembly 125 through contact with digitizer 172.

In an embodiment, immediate character recognition region 128 may be formed by extending digitizer 172 beyond screen 174 in the lengthwise direction. The result is that input can be received in immediate character recognition region 128, but output cannot be displayed.

Other embodiments that use immediate character recognition region 128 may combine digitizer 172 and screen 174. The immediate character recognition region 128 may be a selectable feature that appears in a designated regions of the viewable display. In most conventions, immediate character recognition region 128 appears towards the bottom of the viewable display. This position also corresponds towards a bottom of first segment 110.

The immediate character recognition region 128 of display assembly 125 may correspond to the location of reduced section 118 of first segment 110. Therefore, when second segment 120 is moved into the contracted position, second segment 120 is positioned over immediate character recognition region 128. The contracted position of handheld computer 100 may correspond to a selected mode where character entry is not possible. However, since input mechanisms 132 (FIG. 1) and multi-directional member 134 (FIG. 1) are accessible, data may be selected and displayed when handheld computer 100 is in the contracted position.

D. Attachment of Moveable Segments for Handheld Computer

FIG. 13 is a back isometric view of handheld computer 100, showing a first set of connecting mechanisms for moveably connecting first segment 110 and second segment 120 together on the back side of handheld computer 100. In an embodiment, second segment 120 is provided connecting members 131 on lateral sides 165 of back plate 162. Each connecting member 131 connects to a rail formed by ridges 117 on back surface 114 of handheld computer 100. In an embodiment, connecting members 131 are not removeable from ridges 117, but can be slideably engaged with ridges 117 to move a distance X corresponding to the contracted and extended positions.

The connecting members 131 may be biased and moveable into lateral sides 165 of back plate 165. Engagement apertures 119 and bottom engagement apertures 121 may be provided along ridges 117. The engagement apertures 119 enable connecting members 131 to extend outward and lock second segment 120 into position so as to not be moveable. The connecting members 131 may be accessible from the back panel 162 to release the lock and allow second segment 120 to move relative to first segment 110. The top engagement apertures 119 may be locked into by connecting members 131 to place handheld computer 100 in the contracted position. The bottom engagement apertures 121 may be locked into by connecting members 131 to place handheld computer 100 in the extended position. The back plate 162 may be precluded from moving connecting members 131 beyond top and bottom engagement apertures 119, 121.

FIG. 14 is a front isometric view of handheld computer 100, showing a second set of connecting mechanisms for moveably connecting first segment 110 and second segment 120 together on the front side of handheld computer 100. The second set of connecting mechanisms shown in FIG. 13 may be used jointly with connecting mechanisms shown in FIG. 12. Alternatively, the first or second set of connecting mechanisms may be used alone. Other moveable connecting schemes for moveably joining first segment 110 and second segment 120 are also contemplated by this application.

The housing 164 of second segment 120 includes an interior 167. The interior 167 has connecting structures 169. The connecting structures 169 may be elongate extensions of housing 164, extending at least partially lengthwise within housing 164.

In addition, lateral sides 105 of first segment 110 include rails 159 that are configured to receive connecting structures 169. The rails 159 may be formed into the midframe 145 of first segment 110. Structures within rails 159 and/or on connecting members 169 may facilitate second segment 120 being retained in the contracted or extended position. For example, rails 159 may be provided with internal divots or dimples that require an additional sliding force to enable connecting members 169 to slide past their engagement. The connecting members 169 may include extensions that engage the divots or dimples to further facilitate a retaining engagement. The extensions may be biased. The retaining engagements may be positioned along the length of rails 159 and connecting members 169 corresponding to the contracted and extended positions of handheld computer 100. While the retaining engagements keep second segment 120 in a fixed relationship relative to first segment 110, the retaining engagements can be overcome to enable second segment 120 to slide back and forth. However, an embodiment of the invention provides that second segment 120 cannot be detached from first segment 110.

FIG. 15 is a cross-sectional view taken along lines B-B of FIG. 14, illustrating rails 159 of first segment 110. The rails 159 are provided on midframe 145, between front shell 142 and back shell 144. The rails 159 may include an opening 181 positioned laterally to enable engagement by connecting members 169 of second segment 120. The rails may be T-shaped to enable connecting members 169 to engage rails 159, while allotting for an exterior shell of second segment 120.

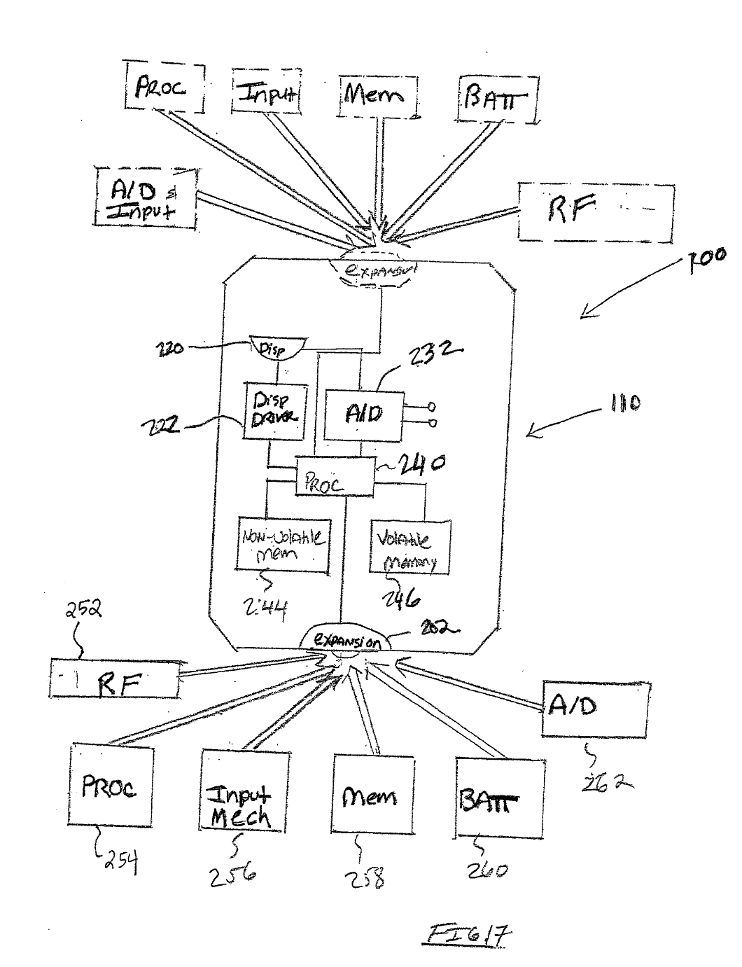

FIG. 16 is a cross-sectional view taken along lines C-C of FIG. 14, illustrating connecting members 169 of second segment 120 configured for engaging rails 159 of first segment 110. The connecting members 159 extend inward from a shell 129 of housing 164 on second segment 120. The connecting members 169 are shaped for rails 159 of first segment 110. To this end, connecting members 169 may include a bulbous end 167, or other configuration to enable a non-detachable and slideable connection with first segment 110.

E. Hardware Diagram

FIG. 17 is a block diagram for a handheld computer 200 formed from moveably coupled segments, under an embodiment of the invention. One of the segments 110, 120 in handheld computer 100 carries a majority of the components for performing the core functions of the handheld computer. In an embodiment, first segment 110 carrying the display assembly 125 for handheld computer 100 is assumed to have the majority of components.

In an embodiment, handheld computer includes a processor 240 coupled to a first memory 244 (non-volatile) and a second memory 246 (volatile). The processor 240 is coupled to a display driver 222. The processor 240 combines with display driver 222 to process and signal data for presentation on a display assembly 220. The display assembly520 includes screen and digitizer.

An analog-digital (AD) converter 232 is coupled to processor 240. One or more channels from A/D converter 232 maybe used to convert analog input provided by the digitizer, or by another analog input mechanism.

The handheld computer 100 may include one or more expansion ports for coupling to accessory devices, such as cradles, modems, memory units, re-chargers and other devices. Examples of expansion ports include serial ports, Universal serial Bus (USB) ports, CompactFlash slots and infra-red ports. In an embodiment shown, a first expansion port 202 enables one or more types of expansion modules to be connected to processor 240. The handheld computer 100 may also include a second expansion port 204 to couple to another accessory device. Each port 202, 204 is shown to be coupled to processor 240, although the components that receive a signal from one of the expansion ports 202, 204 are determined by the type of accessory device selected.

The accessory device that may be coupled to expansion port 202 may be identified by primary functions of their internal components. Each accessory device may include one or more of the following set of components: a radio-frequency transmitter and/or receiver 252, a processor 254, an input mechanism 256, additional memory 258, a battery 260, or another A/D converter 262. The same components may be used with expansion modules to second expansion port 204.

F. Alternative Embodiments

Embodiments described herein have provided for first segment 110 to include a display assembly, and second segment 120 to include input mechanisms. The relationship between the second segment 120 and first segment 110 has included configurations where second segment 120 has been positioned to overlay first segment 110. Other embodiments, however, may provide for the relationship between first segment 110 and second segment 120 to be reversed. For example, first segment 110 may be moved so that a display surface over lays the buttons. The second segment 120 may provide for the display assembly, while first segment 110 provides for input mechanisms. Other examples and configurations are also contemplated by embodiments of the invention.

While embodiments described above provide for housing segments to reduce a length of handheld computer 100, other embodiments may provide for a similar configuration to be used for a width of handheld computer 100, where lateral sides 105, 105 can be moved closer to or further away from each other by first segment 110 and second segment 120.

Embodiments described above provide certain configurations for rails and connecting members. While embodiments described provide for first segment 110 to include rails, and second segment 120 to be configured to engage the rails, other embodiments may reverse the relationship. The second segment 120 may include rails that are engaged by connecting members, ridges or other structures of first segment 110.

G. Conclusion

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

What is claimed is:

1. A handheld computer comprising:
a first segment;
a second segment moveably coupled to the first segment to move between a contracted position and an extended position;
a display assembly provided by the first segment;
a first input mechanism provided by the second segment;
wherein the first input mechanism overlays a portion of the display assembly when the second segment is in the contracted position, and wherein the first input mechanism is positioned away from the display assembly so that the portion of the display assembly is accessible to contact by a user when the second segment is in the extended position.

2. The handheld computer of claim 1, wherein the display assembly includes a first section having a cross-section comprising a digitizer pad and a screen, and a second section comprising the digitizer pad without the screen, and wherein the portion of the display assembly that is overlaid by the first input mechanism includes the second section.

3. The handheld computer of claim 1, wherein the display assembly includes an immediate character recognition section configured to immediately recognize and display assembly a character entry, and wherein the portion of the display assembly that is overlaid by the first input mechanism includes the immediate character recognition section.

4. The handheld computer of claim 1, wherein an exterior surface of the second segment includes a front panel, a plurality of input mechanisms including the first input mechanism being actuatable by the front panel, and wherein the front panel overlays the portion of the display assembly when the second segment is in the contracted position.

5. The handheld computer of claim 1, wherein the first input mechanism includes a multi-directional member.

6. The handheld computer of claim 1, further comprising a plurality of input mechanisms including the first input mechanism, and wherein at least one of the plurality of input mechanisms is a button that can be pressed to cause an input to be entered onto the handheld computer.

7. The handheld computer of claim 1, further comprising a plurality of input mechanisms including the first input mechanism, and wherein at least one of the plurality of input mechanisms is actuatable by detecting surface contact.

8. The handheld computer of claim 1, wherein the first segment includes a first rail, the first rail being positioned on a lateral side of the first segment, and wherein the second segment includes a first connecting member that is engaged to the first rail, the first connecting member slideable along a length of the first rail to enable the second segment to move between the contracted position and the extended position.

9. The handheld computer of claim 1, wherein the first segment includes a first rail and a second rail, and wherein the second segment includes a first connecting member and a second connecting member, the first connecting member being engaged to the first rail, the second connecting member being engaged to the second rail, the first connecting member and the second connecting member each being slideable along a length of the respective first rail and second rail to enable the second segment to move between the contracted position and the extended position.

10. The handheld computer of claim 9, wherein the first segment comprises a front shell, a midframe, and a bottom shell, and wherein the first rail is formed onto a first surface of the midframe, and wherein the second rail is formed onto a second surface of the midframe.

11. The handheld computer of claim 9, wherein the first rail and the second rail extend lengthwise on a back surface of the first segment.

12. The handheld computer of claim 11, wherein the second segment includes a back plate that slides adjacent to the back surface of the handheld computer.

13. The handheld computer of claim 11, wherein the back plate of the second segment includes the first connecting member that slides within the first rail, and the second connecting member that slides within the second rail.

14. The handheld computer of claim 1, wherein the first segment is slideably coupled to the second segment so that the second segment moves in a single direction when moving between the contracted position and the extended position.

15. The handheld computer of claim 1, further comprising a midframe coupled to the first segment and the second segment.

16. The handheld computer of claim 15, wherein the second segment connects to the midframe to move between the contracted position and the extended position.

17. The handheld computer of claim 16, wherein the midframe includes a first rail, and wherein the second segment includes a first connecting member that is engaged to the first rail, the first connecting member moving a distance in the first rail to enable the second segment to move between the contracted position and the extended position.

18. The handheld computer of claim 16, wherein the midframe includes a first rail and a second rail, and wherein the second segment includes a first connecting member and a second connecting member, the first connecting member being engaged to the first rail, the second connecting member being engaged to the second rail, the first connecting member and the second connecting member each moving a distance in the respective first rail and second rail to enable the second segment to move between the contracted position and the extended position.

19. A handheld computer comprising:
a first segment;
a contact-sensitive display assembly accessible on a front surface of the first segment; and
a second segment slideably coupled to the first segment to move between a contracted position and an extended position, the second segment being positioned to overlay and reduce an area of the contact-sensitive display assembly that is accessible to contact when moved from the extended position to the contracted position.

20. The handheld computer of claim 19, wherein the display assembly is contact-sensitive.

21. The handheld computer of claim 20, wherein all of the display assembly is accessible to receive contact as input when the second segment is in the extended position.

22. The handheld computer of claim 20, wherein the display assembly includes an immediate character recognition section configured to immediately recognize and display a character entry, and wherein a portion of the display assembly that is overlaid by the first segment includes the immediate character recognition section.

23. The handheld computer of claim 20, wherein the display assembly includes a first section having a cross-section comprising a digitizer pad and a screen, and a second section comprising the digitizer pad without the screen, and wherein a portion of the display assembly that is overlaid by the first housing segment includes the second section.

24. The handheld computer of claim 19, further comprising a midframe coupled to the first segment and the second segment.

25. The handheld computer of claim 24, wherein the midframe includes a first rail, and wherein the second segment includes a first connecting member that is engaged to the first rail, the first connecting member moving a distance in the first rail to enable the second segment to move between the contracted position and the extended position.

26. The handheld computer of claim 24, wherein the midframe includes a first rail and a second rail, and wherein the second segment includes a first connecting member and a second connecting member, the first connecting member being engaged to the first rail, the second connecting member being engaged to the second rail, the first connecting member and the second connecting member each moving a distance in the respective first rail and second rail to enable the second segment to move between the contracted position and the extended position.

27. A housing assembly for a handheld computer, the housing comprising:
a first housing segment having a front surface, the front surface including an opening to provide access to a display surface for the handheld computer;
a second housing segment moveably coupled to the first housing segment to move between a contracted position and an extended position, the second housing segment overlaying a first region of the opening of the first housing segment when in the contracted position, the first region of the opening that is overlaid by the second housing segment being reduced as the second housing segment is moved from the contracted position towards the extended position.

28. The housing assembly of claim 27, wherein none of the first area is overlaid by the second housing segment when the second housing segment is in the extended position.

29. The housing assembly of claim 27, wherein,
the first housing segment provides a top housing for the handheld computer, the top housing having a reduced section provided towards a bottom of the top housing,
the second housing segment provides a bottom housing for the handheld computer,
the bottom housing being configured to overlay at least a majority of the reduced section of the top housing when in the contracted position, and
the bottom housing being configured to at least not overlay the majority of the reduced section when in the extended position.

30. The housing assembly of claim 29, wherein the second housing segment includes a back plate that extends from the bottom housing to slide along a back surface of the first housing segment when the second housing segment is moved between the contracted position and the extended position.

31. The housing assembly of claim 27, wherein the first housing segment comprises a top shell, a midframe, and a bottom shell.

32. The housing assembly of claim 31, wherein the midframe has a first rail on a first lateral side of the midframe, and a second rail on a second lateral side of the midframe.

33. The housing assembly of claim 31, wherein the second housing segment includes a bottom housing and a back plate, the bottom housing being shaped to abut a top housing of the first housing segment when the second housing segment is moved into the contracted position, the back plate being positioned to slide along a back surface of the first housing segment when the second housing segment is moved between the contracted position and the extended position.

34. The housing assembly of claim 33, wherein an interior surface of the housing includes a first connecting member and a second connecting member, the first connecting member and the second connecting member being slideably engaged with the first rail and the second rail.

35. The housing assembly of claim 32, wherein a back surface of the first housing segment includes a first rail and a second rail, the back surface opposing the front surface.

36. The housing assembly of claim 35, wherein the second housing segment includes a bottom housing and a back plate, the bottom housing being shaped to abut a top housing of the first housing segment when the second housing segment is moved into the contracted position, the back plate being positioned to slide along a back surface of the first housing segment when the second housing segment is moved between the contracted position and the extended position.

37. The housing assembly of claim 36, wherein the back plate is dimensioned to slide between the first rail and the second rail on the back surface of the first housing segment, and wherein the back plate includes a first connecting member to engage the first rail, and a second connecting member to engage the second rail.

38. The housing assembly of claim 27, wherein the first housing segment includes a top shell, a midframe, and a bottom shell, a first rail formed on a first lateral side of the midframe, a second rail formed on a second lateral side of the midframe, and wherein a back surface of the first housing segment includes a third rail and a fourth rail.

39. The housing assembly of claim 38, wherein the second housing segment includes a first bottom housing and a back plate, and wherein the first housing segment includes a top housing and a reduced section, the bottom housing of the second housing segment being moveable over the reduced section of the first housing segment to abut the top housing when the second housing segment is positioned in the contracted position, wherein the back plate is dimensioned to move within the third rail and the fourth rail of the first housing segment to slide along the back surface of the first housing segment, and wherein an interior of the bottom housing includes a first connecting member that is engaged with the first rail provided on the midframe, and a second connecting member that is engaged with the second rail provided on the midframe, the bottom housing.

40. The housing assembly of claim 37, wherein the first connecting member and the second connecting member are each biased, wherein the first rail is configured to retain the first connecting member in an unbiased state at a position corresponding to the contracted position and at another position corresponding to the extended position, and wherein the second rail is configured to retain the second connecting member in an unbiased state at a position corresponding to the contracted position and at another position corresponding to the extended position.

41. A handheld computer comprising:
a first segment providing a first input feature;
a second segment slideably coupled to the first segment to move between a contracted position and an extended position, the second segment providing a second input feature, wherein the second segment overlays a portion of the first segment when moved towards the contracted position so as to reduce a length of the handheld computer.

42. The handheld computer of claim 41, wherein the first input feature corresponds to a contact-sensitive display.

43. The handheld computer of claim 41, wherein the second input feature corresponds to one or more buttons.

44. The handheld computer of claim 41, wherein the first segment has a reduced section that has a lesser thickness than a remainder of the first portion, and wherein the second segment slides over the reduced section when moving towards the contracted position.
